(19) United States
(12) Patent Application Publication
(10) Pub. No.: US 2017/0370255 A1
(43) Pub. Date: Dec. 28, 2017

(54) TANK DEVICE OF AN OIL CIRCUIT OF AN AIRCRAFT ENGINE WITH AN APPLIANCE FOR INTRODUCING OIL

(71) Applicant: Rolls-Royce Deutschland Ltd & Co KG, Blankenfelde-Mahlow (DE)

(72) Inventor: Juergen BEIER, Schulzendorf (DE)

(21) Appl. No.: 15/630,264

(22) Filed: Jun. 22, 2017

(30) Foreign Application Priority Data
Jun. 28, 2016 (DE) 10 2016 111 838.9

(51) Int. Cl. F01M 11/00; F02C 7/06; F01M 1/08; F02K 3/06

(52) U.S. Cl. CPC F01M 11/0004; F02K 3/06; F02C 7/06; F01M 1/08; F01M 2011/0033; F05D 2220/323; F05D 2260/20; F05D 2260/98

(57) ABSTRACT

A tank device of an oil circuit of an aircraft engine for stocking oil inside an interior space that is delimited by a wall, having at least one appliance for introducing oil into the interior space. By means of the appliance for introducing oil, the area of the wall that is arranged above a minimal filling level, as it occurs during operation of an aircraft engine, can be impinged with oil.

This application claims priority to German Patent Application DE102016111838.9 filed Jun. 28, 2016, the entirety of which is incorporated by reference herein.

The invention relates to a tank device of an oil circuit of an aircraft engine for stocking oil, having an interior space that is delimited by a wall and at least one appliance for introducing oil into the interior space according to the kind as it is defined in the generic term of patent claim 1.

Aircraft engines have an oil circuit, the oil of which is used in particular for lubricating and cooling rotor bearings and gear wheels as well as bearings of the gears of the aircraft engine. Pertaining to the oil circuit are in particular a tank device, a pressure pump, oil recirculation pumps, filter, an oil cooler, and a ventilation system. Inside the oil circuit, the oil is conveyed by means of the pressure pump from the tank device and via supply or pressure oil lines as well as a pressure filter to those areas of the engine that are to be impinged by oil. Further, the oil of the oil circuit is pumped in particular via multiple oil recirculation pumps from the respective areas of the engine via a filter appliance and an oil cooler back to the tank device. During operation of the aircraft engine, the oil loading of an air-oil mixture that is created during operation of an aircraft engine is reduced by means of the ventilation system in particular in the area of bearing chambers, and the cleaned air is discharged into the environment, while the oil that is separated from the air-oil mixture remains inside the oil circuit.

In DE 10 2014 113 128 A1, a tank device of an oil circuit for stocking and storing oil is described in more detail. Here, a wall of the tank device delimits an interior space of the tank device. Via an inlet appliance, an air-oil volume flow or so-called oily exhaust air is supplied to the tank device. Oil is separated from the air-oil volume flow by means of an oil separator, wherein the air-oil volume flow having a lower oil loading is subsequently supplied to a conduit. The air-oil volume flow that is conducted inside the conduit is impinged by oil by means of an oil nozzle in order to achieve a further reduction of the oil loading of the air-oil volume flow.

Overall, the tank device has to be designed with a view to a maximal amount of oil that is required during operation of an aircraft engine, an additional amount of oil that cannot be used by the oil circuit, as well as a required expansion space which has to be provided for security reasons in order to prevent an inadmissible overpressure inside the tank device, with no oil being stored inside that expansion space. For weight reasons, efforts are being made to embody the tank device with dimensions that are as small as possible, and also with small wall thicknesses. Because at the same time the tank device has to meet high requirements with respect to fire resistance, the wall areas of the tank device that are subject to high thermal influences during operation and at the same time are not being sufficiently cooled have to be designed with a wall thickness that increases the structural component weight to an undesired extent. Among other components, an upper area of the tank device—as viewed in the installation position of the tank device—that is not impinged by the oil that is stored inside the tank device across substantial operational ranges of an aircraft engine may represent such a wall area. Insufficient cooling of further wall areas of the tank device may, among other things, also occur as a result of the fact that during operation of the aircraft engine an oil volume in the tank device is reduced with respect to an oil volume that corresponds to the maximum filling level, and that the wall areas that are located above it can release thermal energy into the oil volume stored inside the tank device only to a limited degree. For this reason, all wall areas of the tank device that are located above the minimal filling level as it occurs during operation are designed with a greater wall thickness, whereby the structural component weight of the tank device is disadvantageously increased.

It is the objective of the present invention to create a tank device of the kind as it has been described more closely above, which is characterized by a sufficient fire resistance as well as a low weight.

According to the invention, this objective is achieved through a tank device with the features of patent claim 1.

The tank device of an oil circuit of an aircraft engine for stocking oil in an interior space which is delimited by a wall according to the invention is embodied with at least one appliance for introducing oil into the interior space. According to the invention, the area of the wall that is located above a minimal filling level, as it occurs during operation of an aircraft engine, can be impinged by oil by means of the appliance for introducing oil.

By embodying the tank device according to the invention with an active cooling, a sufficient temperature control of all wall areas of the tank device can be realized with little effort, also in the event that a low oil level occurs in the tank device during operation of the aircraft engine.

Consequently, the tank device according to the invention can be embodied with smaller wall thicknesses while having at least an equally high fire resistance, so that it has a lower weight as compared to the tank devices that are known from the state of the art, which are usually made of aluminum and in which a desirably high fire resistance is achieved by a corresponding design of the wall thickness of the tank device. In this manner, the tank device according to the invention, which may be made of aluminum and/or composite materials, can be manufactured in a more cost-effective manner, and an aircraft engine can be operated with lower fuel consumption.

What is understood here by the minimal filling level that occurs during operation of an aircraft engine is the minimal filling level as it [occurs] during normal operation of the aircraft engine, i. e. when a positive weight force that is dominated by the earth's gravity is acting on the oil.

In an advantageous variant of the tank device according to the invention, at least 80% of a surface area of a wall area of the wall that is facing towards the interior space can be directly impinged with oil by means of the appliance for introducing oil, wherein the wall area forms an upper limitation of the interior space in the vertical direction in the mounting condition of the tank device.

In this way, it is achieved in a constructionally simple manner that an oil film is present on the upper wall area due to the oil that is introduced by the appliance directly onto the upper wall area during operation, with the oil film flowing, due to the gravitational force, downwards along a lateral wall area which is located respectively above the currently present oil filling level, and in the direction of the oil that is stored inside the tank device. In addition, during operation of the aircraft engine, there are also oil drops present in the interior space of the tank device which are created as a result of the oil introduced by the appliance being partially deflected off the upper wall area. Turbulences and vortices distribute these oil drops in the interior space, with the oil drops being at least partially separated at the oil film in the area of the wall of the tank device.

The surface area of the wall area of the wall that is to be impinged with oil by at least 80% and that is facing towards the interior space corresponds to a parallel projection of the surface of the upper wall area that is to be impinged with oil by the appliance in the vertical direction of the tank device in the installation position, and in the present case is, by definition, is equal to the cross-sectional surface of the tank device at the height of a maximum filling level of the tank device.

The surface area that is to be impinged with oil by the appliance preferably comprises a central area of the upper limitation, which generally comprises a highest point or highest area of the tank device in the vertical direction in the installation position of the tank device.

In an advantageous embodiment of a tank device according to the invention, the appliance has means for forming an oil spray cone, in particular a nozzle. By directly and/or indirectly impinging the upper wall area with oil drops of the oil spray cone, an oil film is formed on a surface area of the upper wall area that is facing towards the interior space of the tank device, or the oil drops of the oil spray cone merge with an already present oil film that flows down along the lateral walls in the direction of an oil reservoir of the tank device due to the gravitational force, and thus also sprinkles the lateral walls with oil. By a suitable selection of an oil drop size of the oil spray cone and of a pressure with which the oil is directed by the appliance on the upper wall area, the merging of the oil drops with the oil film that is present on the upper wall area can be supported. In addition, depending on the selection of the size of the oil drops and of the selected pressure, it can be achieved that a part of the oil that is directed at the upper wall area is deflected off of the wall area, wherein further wall areas can be sprinkled with oil by the deflected oil drops.

The means or the nozzle of the appliance is preferably embodied so as to form a spray cone that has an opening angle of less than 180°, wherein the opening angle that is chosen for the respective application case can be selected depending on a position of the appliance as well as on a distance of the appliance from the upper wall area, so that in particular at least 80% of the surface area of the upper wall area can be impinged by oil.

In an advantageous embodiment of a tank device according to the invention, the appliance for introducing oil can have means for forming a jet of oil, wherein the upper wall area can be impinged with oil directly and/or indirectly by means of the jet of oil. Here, a central axis of the means, which comprises an outlet opening of the appliance, can have an acute angle of for example up to 30° with respect to the cross-sectional surface of the maximum filling level, so that the oil that exits the appliance substantially in parallel to the central axis of the outlet opening forms an oil film at the wall area or merges with an oil film at the wall area for the most part directly, i. e. without being deflected off of the upper wall area.

In an advantageous embodiment of a tank device according to the invention, a deflection appliance is provided, wherein the appliance is embodied so as to direct oil onto the deflection appliance during operation. By providing the deflection appliance, onto which a jet of oil or an oil spray cone can be directed by the appliance, a position of the appliance in the interior space of the tank device can be flexibly selected while it can still be ensured that the upper wall area is impinged by oil to a desirable extent. The oil that impinges from the appliance onto the deflection appliance is deflected and/or redirected by the deflection appliance, wherein, depending on the arrangement of the deflection appliance and the appliance for introducing oil with respect to each other as well as on the design of the deflection appliance, the surface area of the upper wall area that is impinged by oil can be adjusted in a constructionally simple manner.

In a constructionally simple embodiment of the tank device according to the invention, the deflection appliance has at least one deflection element that is spoon-shaped and/or conical at least in certain areas. Through the spoon-shaped and/or conical embodiment of the deflection element, the oil that is directed by the appliance onto the deflection element in the form of an oil spray cone or a jet of oil can be deflected onto the upper wall area of the tank device in a simple manner, wherein an oil spray cone or a conical oil film or a curtain-like oil cone that is directed onto an upper wall area can be obtained through the deflection in the area of the deflection element.

In an advantageous further development of a tank device according to the invention, the deflection appliance has a first deflection element that is embodied with an opening that is arranged in a central area, and at least one second deflection element, wherein the appliance is embodied so as to directly impinge the second deflection element with oil through the opening of the first deflection element. In particular, the appliance can form a jet of oil with a preferably circular cross section, which for example has a diameter that is twice as large as the opening of the first deflection element. Through a suitable embodiment of the deflection elements, for example with differing opening angles, a desired impingement of the upper wall area by oil can be ensured in a simple manner.

For distributing the oil directed by the appliance onto the wall area in particular across the upper wall area, it is provided in an advantageous embodiment of the invention that at least one deflection appliance for deflecting the oil that is directed by the appliance towards the upper wall area during operation is arranged in the area of the upper wall area. Here, the deflection appliance, which may for example be embodied in a conical manner, is connected to the upper wall area in particular in the impingement area of the oil that is either deflected or directly impinges on the wall area, and has an angle with respect to the upper wall area of the tank device that can be chosen freely depending on the application case, so that an oil film is either formed or maintained on the upper wall area due to the deflection of the oil that impinges on the deflection appliance during operation of the aircraft engine.

In an advantageous embodiment of a tank device according to the invention, an outlet appliance that determines a maximum oil filling level height of the tank device is provided, wherein an outlet area of the appliance, that may for example be embodied in a nozzle-like manner, is arranged in the vertical direction above the outlet appliance in the installation position of the tank device. In this way, it is ensured in a simple manner that the appliance for introducing oil can impinge the wall area with oil to a desired extent in any operating state at all possible filling levels of the oil inside the tank device.

In an embodiment of the tank device that can be adjusted in a simple manner to the respectively available installation space, a central axis of an outlet area of the appliance has an angle between 0° and 180° with respect to a reference axis that is arranged vertically in the installation position of the tank device or with respect to a vertical direction. By means of the appliance, the wall area that forms the upper limitation can thus be directly impinged by oil in a simple manner in the direction of the reference axis from straight below as well as from the side with an angle with respect to the reference axis. In addition, the outlet area of the appliance can also be arranged in the area of the upper wall area, wherein oil can be introduced through the outlet area substantially in the direction of the reference axis downwards onto the deflection appliance. However, generally the central axis of the outlet area can be oriented in any angle with respect to the reference axis if a deflection appliance is correspondingly arranged and embodied.

An outlet area of the appliance can be arranged in the area of the outlet appliance in a central area of the tank device as well as in an edge area of the tank device with respect to a cross-sectional surface of the tank device, so that the arrangement of the appliance can be adjusted in a simple manner to the given installation space conditions.

In order to achieve a desired impingement of the surface area of the upper wall area with oil in a simple manner, in an advantageous embodiment of the tank device according to the invention, multiple appliances for introducing oil into the interior space of the tank device can be provided, which can respectively be embodied in the manner described more closely above. It can also be provided that the appliances are embodied in such a manner that they are embodied so as to jointly ensure the impingement of in particular at least 80% of the surface area of the upper wall area with oil.

Other advantages and advantageous embodiments of the tank device according to the invention follow from the patent claims and the exemplary embodiments that are described in principle in the following by referring to the drawings, wherein, with a view to clarity, in the description of the different exemplary embodiments identical reference signs are used for structural components having the same structure or functionality.

Herein:

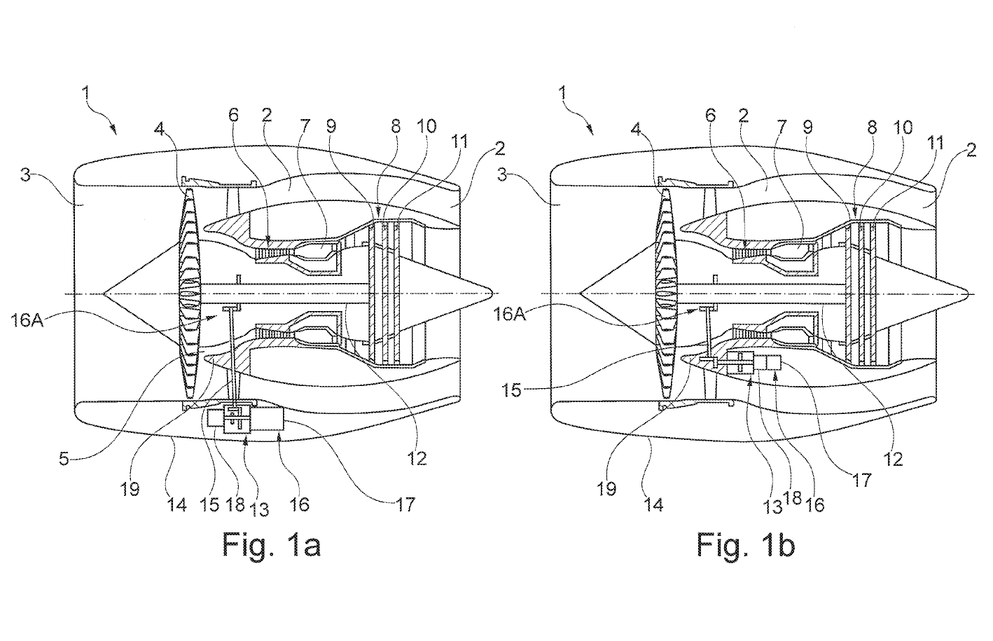

FIG. 1a shows a strongly schematized longitudinal section view of an aircraft engine with an ancillary unit gearing appliance which is arranged inside the fan housing and in the area of which a tank device of an oil circuit is arranged;

FIG. 1b shows a rendering corresponding to FIG. 1 a of an aircraft engine with an ancillary unit gearing appliance that is mounted in the area of the engine core having a tank device of an oil circuit;

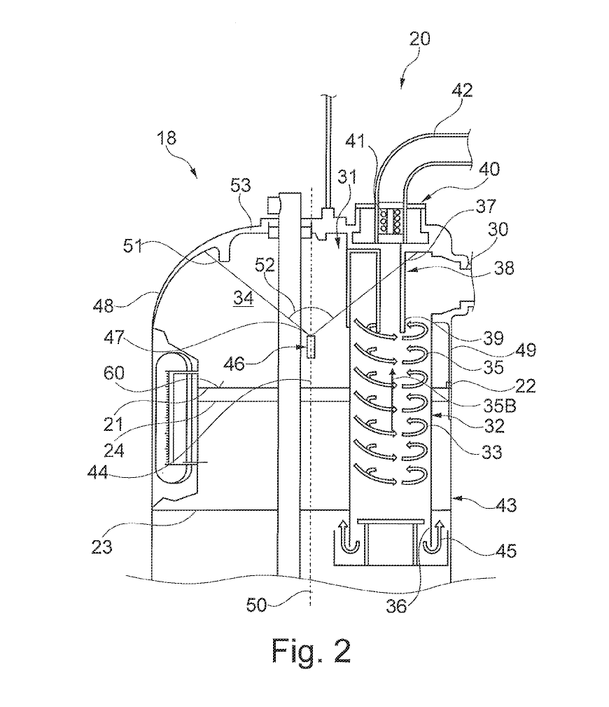

FIG. 2 shows a simplified sectional rendering of the tank device according to FIG. 1a and FIG. 1b in isolation, wherein an appliance for introducing oil is arranged in an interior space of the tank device;

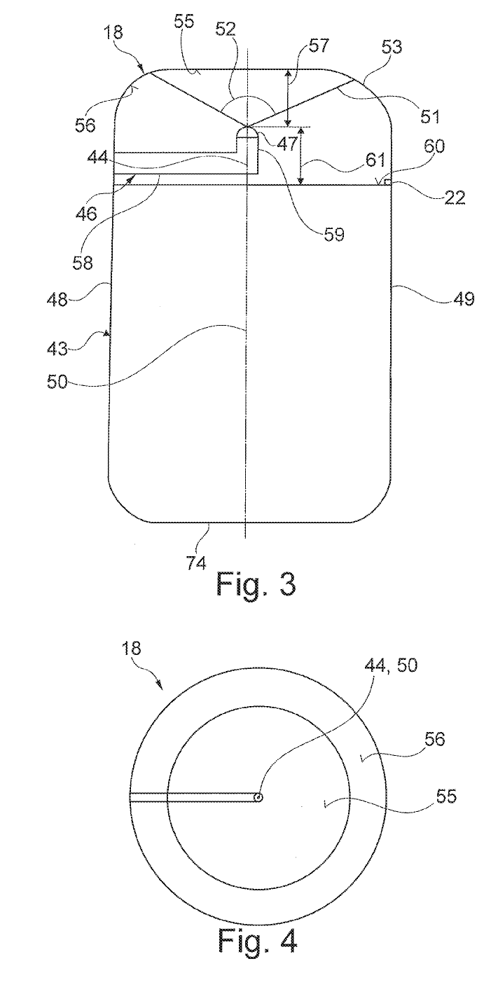

FIG. 3 shows a strongly simplified sectional rendering of the tank device according to FIG. 2;

FIG. 4 shows a strongly simplified top view onto an upper limitation of the tank device from the perspective of the interior space of the tank device;

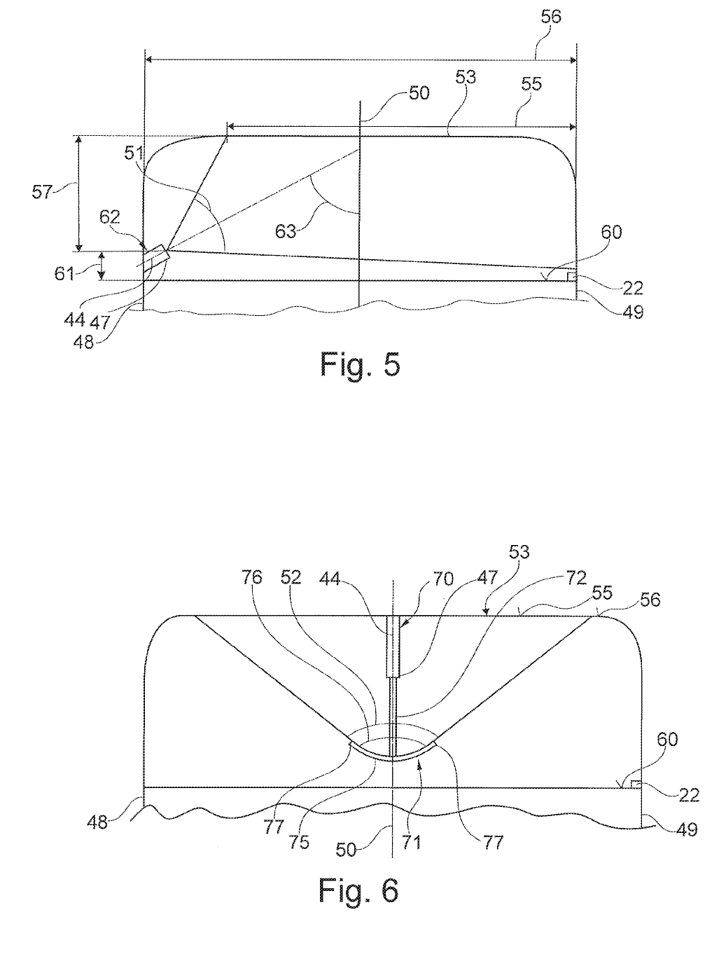

FIG. 5 shows a section of the tank device according to FIG. 3 with an alternative embodiment of an appliance for introducing oil;

FIG. 6 shows a section of the tank device according to FIG. 3 with a further design of an appliance for introducing oil by means of which a jet of oil can be directed onto a deflection appliance into the interior space of the tank device;

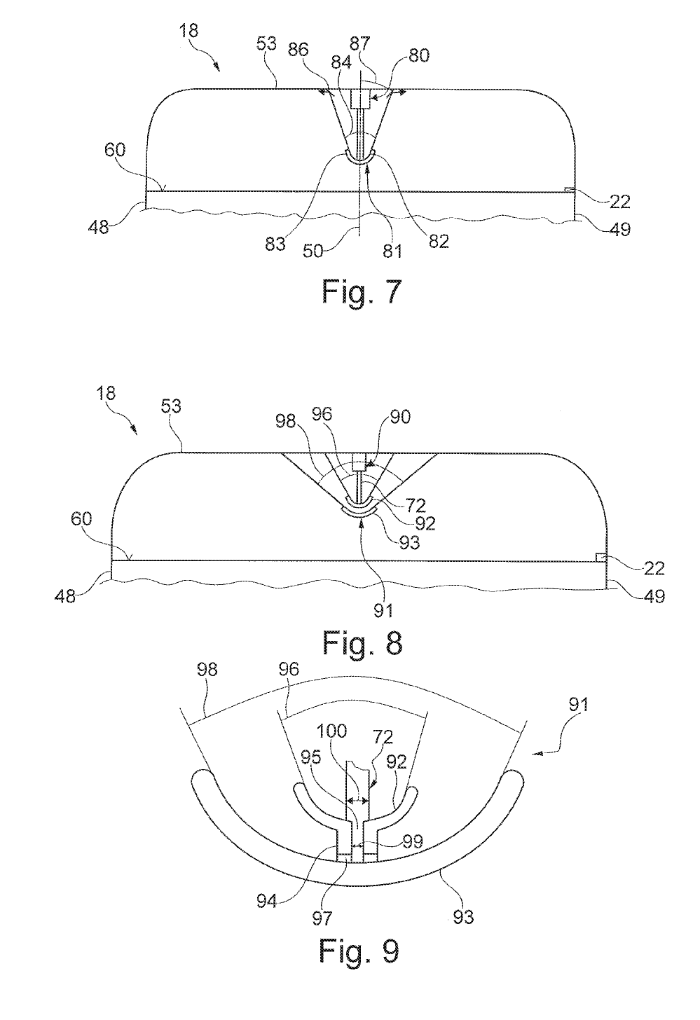

FIG. 7 shows a section of the tank device according to FIG. 3, with an alternatively embodied deflection appliance;

FIG. 8 shows a section of the tank device according to FIG. 3, with a further alternatively embodied deflection appliance; and

FIG. 9 shows a simplified sectional rendering of the deflection appliance according to FIG. 8 in isolation.

An aircraft engine or jet engine 1 are respectively shown in FIG. 1a and FIG. 1b in a longitudinal section view. The aircraft engine 1 is embodied with a bypass channel 2 and an inlet area 3, wherein a fan 4 connects downstream to the inlet area 3 in a per se known manner. Downstream of the fan 4, the fluid flow inside the aircraft engine 1 is in turn divided into a bypass flow and a core flow, wherein the bypass flow flows through the bypass channel 2 and the core flow flows into an engine core 5, which is again embodied in a per se known manner with a compressor appliance 6, a burner 7, and a turbine appliance 8. In the present case, the turbine appliance 8 has three rotor devices 9, 10 and 11, which are embodied in a substantially comparable design and are connected to an engine shaft 12.

In the embodiment of the aircraft engine 1 according to FIG. 1a, an ancillary unit gearing appliance 13 is arranged in an outer engine housing 14 that delimits the bypass channel 2 and represents the outer circumferential area of the jet engine 1. In the present case, the ancillary unit gearing appliance 13 is connected to the engine shaft 12 through a drive shaft 15 that extends in the radial direction of the jet engine 1 via an inner gear 16A, and is thus driven or supplied with a torsional moment by the engine shaft 12 during operation of the jet engine 1. The ancillary unit gearing appliance 13 supplies different ancillary units 16 as well as an oil separator 17, which is also referred to as a breather, with a torsional moment to a desired extent. In the area of the ancillary unit gearing appliance 13, also a tank device 18 of an oil circuit 20 of the aircraft engine 1 is additionally provided, representing a hydraulic fluid reservoir from which oil for cooling and lubricating different areas of the aircraft engine 1—such as bearing appliances, gear wheel pairs of the inner gear 16A and the ancillary unit gearing appliance 13, as well as further assembly groups of the aircraft engine 1 that are to be cooled and lubricated—is extracted.

In contrast to that, in the embodiment of the aircraft engine 1 according to FIG. 1b, the ancillary unit gearing appliance 13 with the ancillary units 16, the oil separator 17 and the tank device 18 is arranged in the radial direction between the bypass channel 2 and the engine core 5 inside a structural component 19 that delimits the bypass channel 2 and the engine core 5.

A preferred exemplary embodiment of the tank device 18 according to the invention is shown in FIG. 2, wherein the tank device 18 is embodied with an inlet appliance 30. During operation of the aircraft engine 1, an air-oil mixture is created in areas impinged with oil, for example in bearing appliances, in the area of gear wheel pairs of the inner gear 16A and the ancillary unit gearing appliance 13, which can be supplied to the tank device 18 via the inlet appliance 30 as an air-oil volume flow. The air-oil volume flow is supplied to a separation appliance 32, which in the present case is embodied as a cyclone, within a wall 43 that delimits an interior space 31 of the tank device 18. At that, the cyclone 32 has a wall area 33 that in the present case is substantially cylindrical, and through which the cyclone 32 is separated from an expansion space 34 of the tank device 18 at least in certain areas. The expansion space 34 is located above a current oil level 24 in the tank device 18, wherein a maximum filling level or oil level of the tank device 18 is determined by a schematically shown outlet appliance 22 and is indicated more clearly by the line 21. FIG. 2 also shows a minimal filling level 23 as it occurs during operation of the aircraft engine 1.

The air-oil volume flow is introduced into the cyclone 32 eccentrically and tangentially with respect to the wall area 33 in an upper area of the cyclone 32, as it is positioned in the mounting condition of the tank device 18. From the inlet appliance 30, the air-oil volume flow flows downwards in the area of the cyclone 32 in a spiraling manner corresponding to the arrows 35 along the wall area 33 of the cyclone. Due to the centrifugal force that is acting in the course of this process, particularly large and heavy oil drops of the air-oil volume flow are separated at the wall area 33 of the cyclone 32, forming an oil film there. Due to the gravitational force, the oil film is drained downwards along the wall area 33 and flows through an outlet opening 36 of the cyclone 32 in the direction of the arrows 45 into an oil reservoir of the tank device 18.

Due to the dynamic conditions as they are present in the area of the cyclone 32, an air-oil volume flow rises inside the cyclone 32 in the area of a central axis of the cyclone 32 in the direction of the arrows 35B. Being carried along in this air-oil volume flow are particularly small oil drops that have not been separated in the area of the cyclone 32, as well as oil drops of different sizes passing from the air-oil volume flow that flows downwards in a spiral-like manner inside the cyclone 32. In the present case, the air-oil volume flow that rises in the direction of the arrows 35B inside the cyclone 32 is supplied to a conduit area 38, which is delimited by a wall 37 and in the present case is embodied in a cylindrical manner, in an upper area that is located approximately at the height of the inlet appliance 30. On a side of the conduit area 38 that is facing away from an inlet opening 39 of the conduit area 38, the latter adjoins a valve appliance, which in the present case is embodied as a spring-preloaded pressure limiting valve 41, in the area of an outlet appliance 40 of the tank device 18, wherein downstream of the pressure limiting valve 41 a volume flow is supplied to a conduit 42, via which the volume flow that is discharged from the tank device 18 can be supplied to another separation appliance or can be discharged into an environment, as necessary.

What is further provided is an appliance 46 for introducing oil into the interior space 31 of the tank device 18. The appliance 46, which is shown in FIG. 2 only in a strongly simplified manner, has an outlet area that is embodied as a nozzle 47, wherein, in the present case, a central axis 44 of the appliance 46 in the outlet area 47 is aligned substantially in the vertical direction in the shown installation position of the tank device 18, i. e. in parallel to a central axis 50 of the tank device 18, just like all lateral wall areas 48, 49 of the tank device 18 which is embodied with a substantially circular cross section here. In addition, the central axis 44 of the appliance 46 is congruent with the central axis 50 that represents a reference axis extending in the vertical direction, i. e. it is arranged centrally depending on the chosen cross section of the tank device 18.

The nozzle 47 of the appliance 46 represents a means for introducing an oil spray mist in the form of an oil spray cone 51 that is shown in a schematized manner in FIG. 2 and FIG. 3, wherein the oil spray cone 51 is characterized by an opening angle 52 that is larger than 90° in the present case. In the tank device 18, which is depicted in a strongly schematized manner in FIG. 3, it is shown that the oil spray mist of the appliance 46 is directed towards an upper wall area 53 of the tank device 18 which represents an upper limitation of the tank device 18.

By means of the oil that is discharged from the appliance 46 through the nozzle-like outlet area 47, a surface area 55 of the upper wall area 53, which is shown in more detail in FIG. 4, can substantially be directly impinged with oil in its entirety in the present case, with the oil drops of the appliance 46 merging with an oil film that forms during operation on the upper wall area 53. In the present case, the surface area 55 comprises approximately 80% of a total surface area 56 of the upper wall area 53.

In the present case, the entire surface area 56 of the upper wall area 53 is equal with respect to its size to the cross-sectional surface 60 of the tank device 18 that extends perpendicular to the central axis 50 at the height of the outlet appliance 22 which defines the maximum filling level height. The surface area 56 is in turn defined by a parallel projection of the surface of the upper wall area 53 to be impinged with oil by means of the appliance 46 in the vertical direction of the tank device 18 in the installation position.

The surface areas 55 and 56, which in the present case are approximately circular, are shown in more detail in FIG. 4, wherein in the present case the surface area 56 completely surrounds the surface area 55. In the present case, the surface area 55 is calculated as the tangent of half the opening angle 52 of the oil spray cone 51 multiplied by the squared distance 57 of the outlet area 47 from the upper wall area 53 multiplied by Pi. The opening angle 52 of the oil spray cone 51 is selected in particular depending on the distance 57 of the outlet area 47 from the upper wall area 53, so that in the present case at least 80% of the surface area 56 is directly impinged by oil.

In order to ensure that the appliance 46 is fully operative in all operational states of the aircraft engine 1 when a positive weight force is acting on it, the outlet area 47 of the appliance 46 is arranged above the cross-sectional surface 60 that defines the maximum filling level height, and has a distance 61 of more than zero with respect to the cross-sectional surface 60.

As shown in FIG. 3, in the present case, the appliance 46 is fixedly connected to the lateral wall area 48 of the tank device 18 and has a conduit area 58 that extends starting from the lateral wall area 48 in the direction of the central axis 50 of the tank device 18, and that represents an oil supply line and in the present case is oriented so as to be substantially perpendicular to the central axis 50 of the tank device 18. In the area of the central axis 50, a further conduit area 59 connects to the conduit area 58, and is arranged in a substantially concentric manner with respect to the central axis 50 of the tank device 18, wherein, in the present case, the central axis 44 of the outlet area 47 is substantially congruent with the central axis 50 of the tank device 18, i. e. an angle between the central axis 50 of the tank device and the central axis 44 of the outlet area 47 equals zero.

Through the oil that is sprayed by the appliance 46 in the direction of the upper wall area 53, an oil film forms during operation of the aircraft engine 1 in the area of the surface area 55, which—due to the gravitational force as well as the fluid dynamics, among other factors—is distributed in particular in the area of the entire surface area 56 and flows downwards in the direction of the oil that is stored inside the tank device 18 via the lateral wall areas 48, 49, so that, by means of the appliance 46, that area of the wall 43 of the tank device 18 that is arranged above the current filling level 24 that occurs during operation of the aircraft engine 1 and lies between the minimal filling level 23 and the maximum filling level 21 in the vertical direction can be impinged by oil. In addition, where required also those wall areas of the expansion space 34 that are not directly impinged with oil by the appliance 46 are likewise sprinkled with oil through oil drops that are deflected as they impact the upper wall area 53, so that in particular all wall areas of the expansion space 34 are covered with an oil film during operation.

By impinging the walls 48, 49, 53 of the tank device 18 with oil during operation of the aircraft engine, these walls 48, 49, 53 are cooled, so that the tank device 18 is rendered sufficiently fire-resistant in this manner. Accordingly, in the present case, a tank device 18 that is embodied with an aluminum wall 43 can be embodied with advantageously small wall thicknesses, and thus advantageously has only a low weight.

In the following, further exemplary embodiments with alternatively embodied appliances for introducing oil into the interior space 31 of the tank device 18 are described in more detail with respect to their arrangement in the interior space 31 and their functionality, wherein general reference is made to the above description so as to avoid redundancies.

FIG. 5 shows an appliance 62 for spraying in oil, with its outlet area, which is embodied as a nozzle 47 in this case, being arranged in an area that is positioned in the proximity of a lateral wall area 48 of the tank device 18. At that, the central axis 44 of the outlet area 47 is inclined with respect to the central axis 50 of the tank device 18 or with respect to a vertical axis as it is present in an installation position of the tank device 18 by an angle 63 of presently approximately 60°. By means of the appliance 62, an oil spray cone 51 can be introduced into the interior space 31 of the tank device 18 with an opening angle 52 of in presently approximately 60°, wherein in particular at least 80% of the surface area 56 of the upper wall area 53 can be directly impinged with oil by means of the sprayed-in oil. Thus, by means of the appliance 62, in addition to a part of the surface area 56 of the upper wall area 53, also a part of a lateral wall area 49 of the tank device 18 that is arranged opposite the lateral wall area 48 at which the appliance 62 is arranged can be directly impinged by oil. That area of the tank device 18 which is not directly impinged by oil in the course of this process is also cooled to a satisfactory extend thanks to the cooling effect of the oil in the impact area.

A further exemplary embodiment of an appliance 70 for introducing oil into the interior space 31 of the tank device 18 is shown in FIG. 6. Here, the appliance 70 is arranged in an area of the upper wall area 53 that is central with respect to the central axis 50, wherein a central axis 44 of the outlet area 47 of the appliance 70 is arranged in parallel and in particular so as to be congruent with the central axis 50 of the tank device 18. Here, an angle between the central axis 44 of the outlet area 47 and the central axis 50 of the tank device 50 is 180°. At that, the appliance 70 is embodied for the purpose of introducing a jet of oil 72 of a defined diameter 73 into the interior space 31, wherein the jet of oil 72 can be introduced in the direction of a lower wall area 74 downwards into the interior space 31 of the tank device 18 in the direction of a deflection appliance 71.

In the present case, the deflection appliance 71 that is arranged above the maximum filling level 21 of the tank device 18 in the vertical direction is embodied with a spoon-shaped deflection element 75 or impact element, wherein an edge area 77 of the deflection element 75 is characterized by having an opening angle 76. During operation of the appliance 70, the jet of oil 72 hits the deflection appliance 71 in particular centrally, and is deflected by the deflection element 75 of the deflection appliance 71. At that, the oil that is deflected in the area of the deflection element 75 forms a particularly conical oil film downstream of the deflection element 75, with the oil film being characterized by an angle 52 that substantially corresponds to the opening angle 76. In the present case, at least 80% of the surface area 56 of the upper wall area 53 is impinged by oil during operation of the aircraft engine 1 through the oil that is deflected by means of the deflection element 75.

In contrast to the embodiments according to FIG. 2 to FIG. 5, the upper wall area 53 of the tank device 18 is impinged by oil indirectly by means of the appliance 70.

FIG. 7 shows a further embodiment of an appliance 80 for introducing a jet of oil 72 into the interior space 31 of the tank device 18, which substantially corresponds to the appliance 70. Again, a jet of oil 72 can be directed in the direction of the central axis 50 of the tank device 18 downwards onto a deflection appliance 81 by means of the appliance 80. In contrast to the deflection element 75 of the deflection appliance 71, the deflection appliance 81 has a deflection element 82, with its edge area 83 enclosing an angle 84 that is smaller than the angle 76 of the deflection appliance 71, and in the present case is approximately 20° to 30°, for example. Here, a surface area 85 of the upper wall area 53 that is covered by the oil directly impinging on the upper wall area 53 is approximately 20% of the surface area 56 of the upper wall area 53, for example.

In the present case, a deflection appliance 86 is arranged at the upper wall area 53 in those areas where the oil, which here is deflected by the deflection appliance 81 in a conical manner, impinges on the upper wall area 53. In the shown exemplary embodiment, the deflection appliance 86 is arranged so as to be substantially rotationally symmetrical to the central axis 50 of the tank device 18, wherein the deflection appliance 86 is embodied in a sheet-metal-like manner, as can be seen in more detail in the cross section according to FIG. 7. The sheet-metal-like section of the deflection appliance 86, which is flat in the cross section, has an angle 87 with respect to the central axis 50 of the tank device 18 or with respect to a vertical line which may lie between 30° and 50°, for example. At that, the angle 87 is chosen in such a manner that the oil impinging on the deflection appliance 86 is distributed by the deflection appliance 86 to a desired extent across the surface area 56 of the upper wall area 53 which is facing towards the interior space 31. For the purpose of guiding the oil that is deflected in the area of the deflection appliance 86, grooves or notches may be provided in the area of the upper wall area 53, which in particular guide the oil radially outwards with respect to the central axis 50 of the tank device 18.

Here, the embodiment according to FIG. 7 is characterized by a high cooling performance in connection with a comparatively high oil requirement.

In the embodiment according to FIG. 7A, a sufficient impingement of the surface area 56 with oil can optionally also be achieved without the deflection appliance 86 if the oil that is directed by the deflection appliance 81 onto the upper wall area 53 is deflected off of the same and a sufficiently large area of the surface area 56 is impinged with oil by the deflected oil during operation of the aircraft engine 1.

A further embodiment of an appliance 90 for introducing a jet of oil 72 into the interior space 31 of the tank device 18 can be seen in FIG. 8 and FIG. 9, wherein the appliance 90 substantially corresponds to appliance 70 or appliance 80. Again, a deflection appliance 91 is provided, which in the present case is embodied with two deflection elements 92, 93, wherein a first deflection element 92 is arranged closer to the outlet area 47 of the appliance 90 than a second deflection element 93. The deflection elements 92, 93 are embodied so as to be substantially rotationally symmetrical with respect to a jet of oil 72 that is formed during operation of the appliance 90 or with respect to the central axis 50 of the tank device 18, and in the present case are connected to each other by means of a tubular section 94. The first deflection element 92 has a circular recess 95 in a central area, the diameter 99 of which is of the same size as the internal diameter of the tubular section 94 in the present case, corresponding to half a diameter 100 of the jet of oil 72 that is formed during operation of the appliance 90.

Thus, during operation of the appliance 90, a portion of the jet of oil 72 that is central with respect to the central axis 44 of the outlet area 47 of the appliance 90 is guided through the recess 94 of the first deflection element 92 in the direction of the second deflection element 93, and is redirected or deflected by the deflection element 93 in the manner described above so that oil is directed onto the upper wall area 53 in a conical manner with an opening angle 96 of 90°, for example. To avoid that the oil that is deflected in the area of the second deflection element 93 is obstructed by the tubular section 94 in an undesirable manner, the tubular section 94 has at least one throughflow passage 96 for the oil in an area adjacent to the second deflection element 93. That portion of the jet of oil 72 that impinges onto the first deflection element 92 is deflected by the first deflection element 92 in such a manner that the oil is deflected again in a curtain-like manner onto the upper wall area 53 with an opening angle 98 that is smaller than the opening angle 96.

In that area in which the oil that is deflected by the first deflection element 92 impinges on the upper wall area 53, a deflection appliance can be arranged that is comparable to the deflection appliance 86. Alternatively or additionally, a deflection appliance comparable to the deflection appliance 86 can also be provided in that area in which the oil deflected via the second deflection element 93 impinges onto the upper wall area 53.

### Parts List

1 aircraft engine, jet engine
2 bypass channel
3 inlet area
4 fan
5 engine core
6 compressor appliance
7 burner
8 turbine appliance
9, 10, 11 rotor device
12 engine shaft
13 ancillary unit gearing appliance
14 engine housing
15 drive shaft
16 ancillary units
16A inner gear
17 oil separator
18 tank device
20 oil circuit
21 line; maximum filling level
22 outlet appliance
23 minimal filling level
30 inlet appliance
31 interior space of the tank device
32 separation appliance, cyclone
33 wall area of the separation appliance
34 expansion space of the tank device
35, 35B arrow
36 outlet opening of the cyclone
37 wall of the conduit area
38 conduit area
39 inlet opening of the conduit area
40 outlet appliance of the tank device
41 valve appliance, pressure limiting valve
42 conduit
43 wall of the tank device
44 central axis of the outlet area
45 arrows
46 appliance for introducing oil
47 means; outlet area of the appliance
48, 49 lateral wall area of the tank device
50 central axis of the tank device
51 oil spray cone
52 opening angle
53 upper wall area of the tank device
55 surface area
56 surface area
57 distance
58 conduit area
59 further conduit area
60 cross-sectional surface
61 distance
62 appliance for introducing oil
63 angle
70 appliance for introducing oil
71 deflection appliance
72 jet of oil
73 diameter of the jet of oil
74 lower wall area of the tank device
75 deflection element
76 angle
77 edge area of the deflection element
80 appliance for introducing oil
81 deflection appliance
82 deflection element
83 edge area of the deflection element
84 angle
86 deflection appliance
87 angle
90 appliance for introducing oil
91 deflection appliance
92 first deflection element
93 second deflection element
94 tubular section
95 recess
96 opening angle
97 throughflow passage
98 opening angle
99 diameter of the recess
100 diameter of the jet of oil

1. A tank device of an oil circuit of an aircraft engine for stocking oil inside an interior space that is delimited by a wall, having at least one appliance for introducing oil into the interior space, wherein the area of the wall that is arranged above a minimal filling level as it occurs during operation of an aircraft engine can be impinged by oil by means of the appliance for introducing oil.

2. The tank device according to claim 1, wherein at least 80% of a surface area of a wall area of the wall that faces towards the interior space can be directly impinged with oil by means of the appliance for introducing oil, wherein the wall area forms an upper limitation of the interior space in the mounting condition of the tank device.

3. The tank device according to claim 1, wherein the appliance has means for forming an oil spray cone.

4. The tank device according to claim 3, wherein the appliance has means for forming an oil spray cone that has an opening angle of smaller than 180°.

5. The tank device according to claim 1, wherein the appliance has means for forming a jet of oil.

6. The tank device according to claim 1, wherein a deflection appliance is provided, wherein the appliance is embodied for the purpose of directing oil onto the deflection appliance during operation.

7. The tank device according to claim 6, wherein the deflection appliance has at least one deflection element that is spoon-shaped and/or conical at least in certain areas.

8. The tank device according to claim 6, wherein the deflection appliance has a first deflection element that is embodied with an opening that is arranged in a central area and at least one second deflection element, wherein the appliance is embodied for the direct impingement of the second deflection element with oil through the opening of the first deflection element.

9. The tank device according to claim 1, wherein at least one deflection appliance for deflecting the oil that is directed during operation through the appliance onto the wall area forming the upper limitation is arranged in that area of the wall area that forms the upper limitation.

10. The tank device according to claim 1, wherein an outlet appliance is provided that determines the maximum filling level height of the tank device, wherein an outlet area of the appliance is arranged above the outlet appliance in the installation position of the tank device.

11. The tank device according to claim 1, wherein a central axis of an outlet area of the appliance has an angle of between 0° and 180° with respect to a reference axis that is arranged vertically in the installation position of the tank device.

12. The tank device according to claim 1, wherein an outlet area of the appliance is arranged in a central area of the tank device with respect to a cross-sectional surface of the tank device in the area of the outlet appliance.

13. The tank device according to claim 1, wherein an outlet area of the appliance is arranged in an edge area of the tank device with respect to a cross-sectional surface of the tank device in the area of the outlet appliance.

14. The tank device according to claim 1, wherein multiple appliances for introducing oil into the interior space of the tank device are provided.
